(19) United States
(12) Patent Application Publication
(10) Pub. No.: US 2007/0109635 A1
(43) Pub. Date: May 17, 2007

(54) Device for fastening imaging units on an observing telescope

(75) Inventors: Stephan Albrecht, Giessen (DE); Ulrich Ehmes, Porto (PT); Miguel Ferreira, Brufe (PT); Arno Sehrt, Wetzlar (DE)

Correspondence Address: FOLEY AND LARDNER LLP;SUITE 500, 3000 K STREET NW, WASHINGTON, DC, 20007, US

(73) Assignee: LEICA CAMERA AG

(21) Appl. No.: 11/580,278

(22) Filed: Oct. 13, 2006

(30) Foreign Application Priority Data
Oct. 13, 2005 (DE) 10 2005 049 405.6
Jan. 4, 2006 (DE) 10 2006 000 754.9

(51) Int. Cl. G02B 21/06

(52) U.S. Cl. 359/386

(57) ABSTRACT

A Device (1) for fastening imaging units on an observing telescope with exchangeable eyepieces is described that has two cylinders (2, 3) that are supported coaxially with one another and are guided in an axially displaceable fashion, it being possible for one cylinder (3) to be fastened on the eyepiece housing, and the other cylinder (2) having a clamping device (13), arranged offset laterally from the cylinder axis, for holding an imaging unit.

The invention relates to a device for fastening different imaging units on an observing telescope with exchangeable eyepieces.

In addition to visual observation, observing telescopes can also be used as object glasses of large focal length, and thus of high magnification, for imaging units.

With conventional telescopes, no connection is provided for fastening an imaging unit such as, for example, an analog or digital photographic camera, a camcorder or the like. A multiplicity of auxiliary structures and adapters have therefore become known for connecting a camera to a telescope.

One known possibility exists in removing the exchangeable eyepiece of a telescope and replacing it with an adapter that can be screwed on or fitted on. The adapter has a complicated lens arrangement replacing the eyepiece optics, and a bayonet connection for holding the camera. Because of the required optical components, such adapters are expensive and, additionally, suitable exclusively for the use of specific cameras provided with a fitting bayonet connection. If, moreover, the aim is to be able to use the telescope to observe the object to be recorded, this observation must be performed through the finder of the camera, and therefore presupposes the use of a mirror reflex camera.

U.S. Pat. No. 5,053,794 discloses an adapter of simpler configuration that is fastened directly on the eyepiece of the telescope. The camera lens is screwed with its filter holding thread onto the adapter. The flush alignment of the optical axis of the camera lens with that of the telescope is performed by means of a metal spring, which can be set radially by three setscrews, in the eyepiece region of the adapter. Use can be made only of cameras with lenses that have a standardized filter holding thread. Further intermediate adapter rings are otherwise required. Modern digital compact cameras without filter threads cannot be used.

DE 102 44 669 A1 discloses a device for holding a camera behind a telescope, it being possible for the camera to be swung between a recording position and a playback position. The device comprises a complicated mechanical structure that is fastened with the aid of a screw on the telescope tripod bush. The device cannot be used on a telescope without tripod bush. It is heavy and cumbersome. The camera is adjusted via a complicated mechanical system, consisting of a number of rail elements that can be adjusted for length, height and at the side, downstream of the eyepiece of the telescope. It is impossible for the recorded image to be switched from vertical to horizontal format. The camera must have a tripod bush in order to be fastened on the device. The field of use of this device is therefore restricted to a few camera models.

EP 1 477 763 A1 discloses the provision of a folding device, which can be clamped on the telescope eyepiece, for holding a camera. Because of the adapter fastened thereon, the eyepiece cannot be changed without first removing the adapter. The alignment of the camera downstream of the telescope eyepiece is likewise performed via a camera holder that can be adjusted for length, height and at the side. Taking vertical format pictures is not possible without changing the telescope alignment. In the case of this device, as well, the camera is fastened by means of a screw which engages in the camera tripod bush. Camera models without tripod bushes cannot be fastened on this device.

DE 297 22 332 U1 discloses an adapter for adapting an optical imaging system that can be connected on one of its sides to the filter thread of a camera lens, and on its other side to the image output of the optical imaging system. The adapter has a tube of variable length, which includes an image adjusting optics consisting of one or more lenses.

U.S. Pat. No. 6,781,630 B2 describes an adapter system consisting of a first and a second adapter part that likewise has a tube of variable length and includes an optics for influencing the imaging. The adapter is used to place a digital camera onto a microscope.

It is an object of the invention to make available a device for fastening the most varied imaging units on an observing telescope that can be used universally, is easy to manipulate, can be used without being restricted to specific individual imaging units, and at the same time can be produced cost effectively.

This object is achieved according to the invention in the case of a device of the type mentioned at the beginning by virtue of the fact that the device has two cylinders that are supported coaxially with one another and are guided in an axially displaceable fashion, it being possible for one cylinder to be fastened on the eyepiece housing or, via an adapter device surrounding the eyepiece housing, on the housing of the observing telescope, and the other cylinder having a clamping device, arranged offset laterally from the cylinder axis, for holding an imaging unit. The cylinders that are supported coaxially with one another and are guided in a displaceable fashion enable the device to be adjusted longitudinally in a simple way. Imaging units with lenses of different length and different focal lengths can be used, since their lens fore-parts can dip into the cylinders. In this way, the lenses can be positioned at an axial distance from the eyepiece housing that yields a good image. The fastening of the cylinder on the eyepiece housing enables an uncomplicated mounting and dismounting of the device on the telescope. An alternative design of the invention that is particularly easy to manipulate consists in providing an adapter device, which can be fastened permanently on the housing of the observing telescope via two clamping screws, for example, and surrounds the eyepiece housing, for coupling the cylinder. In its coupling region, the adapter device has a plug or snap in connection for fastening the cylinder on the adapter device in a reproducible and rotationally secure fashion, and therefore with reference to the optical axis of the eyepiece. There is no need for the telescope to have a tripod bush for fastening the device. A clamping device arranged in a fashion laterally offset from the cylinder axis advantageously enables virtually all the imaging units to be held, including those without tripod bushes such as, for example, camera cell phones. The acting position of the clamping device on the housing surfaces of the imaging unit can easily be varied by rotating the device about the cylinder axis. In the case of conventional cameras, which are usually of rectangular design, the housing region situated on the left of the taking lens in the photographer's viewing direction is held with the left hand, and the release button, which is situated at the top on the right of the taking lens, can be operated with the right hand. In order to hold such cameras, the clamping device can advantageously be brought into a position on the left of the cylinder axis by rotating the device such that it clamps the camera from above and below in the housing region on the left. The operating elements, in particular the release button, are then effectively accessible on the right side of the camera. It is possible in this way to record both images in horizontal format and, after a simple rotation of the device by 90°, images in vertical format. After this rotation, the clamping device is located above or below the cylinder axis in the viewing direction, and grips the housing regions of the camera from the left and from the right. This alignment of the device is outstandingly suitable for holding camera cell phones.

In an advantageous refinement of the device, the cylinder bearing the clamping device is guided rectilinearly as outer cylinder on an inner cylinder that can be fastened on the eyepiece housing. Once a rotary alignment of the clamping device has been carried out relative to the eyepiece housing for the purpose of imaging either in horizontal format or in vertical format, it is maintained because of the rectilinear guidance even when the axial distance is varied by displacement of the outer cylinder on the inner cylinder. For the purpose of more effective operability, the cylinder bearing the clamping device is designed as an outer cylinder. An axial displacement of the clamping device is enabled in this way both by gripping the clamping device, and by gripping the outer cylinder.

In a further refinement of the device, the outer cylinder can be fixed in variable extended positions on the inner cylinder. It is possible with particular advantage to provide on the inner cylinder markings that facilitate the finding of previously determined, ideal extended positions for specific imaging units.

In an advantageous refinement of the device, a first clamping screw connection with a fixing nut clamping the outer cylinder against the inner cylinder is provided for fixing the outer cylinder on the inner cylinder. The fixing nut cooperates in this arrangement with a threaded rod that is fastened to the inner cylinder and simultaneously acts as the guide pin of a pin-slot connection, and in this way forms a rectilinear guide.

In the case of a particularly advantageous refinement of the device, on the eyepiece side the inner cylinder has one or more orientation cutouts arranged on the circumference. Preferably four orientation cutouts arranged at regular intervals on the circumference facilitate, in particular, the vertical or horizontal alignment of the clamping device relative to the edges of the image. The width of the orientation cutouts is advantageously adapted to the housing width of locking mechanisms possibly present on the telescope eyepiece housing. Orientation blocks subsequently attached to the eyepiece housing can also facilitate the alignment. Alternatively, or in addition, a further clamping screw device is provided on the eyepiece side on the inner cylinder for fastening on the eyepiece housing. In this case, a screw advantageously presses against a broad plastic spring ring integrated in a radial groove formed inside on the inner cylinder, in order to generate a force acting as uniformly as possible on the circumference of the eyepiece housing. The plastic spring ring is secured in the groove against slipping by a securing pin. A secure fastening of the device is possible in this way even when a heavy camera is being held.

Secure clamping is also attained by a clamping jaw, in the shape of a circular segment, that can be operated via a screw connection and that is likewise guided in a radial groove formed inside on the inner cylinder.

One or more operating apertures are ideally provided on the inner cylinder for adjusting a zoom eyepiece. In the region of these operating apertures, the outer cylinder has corresponding cutouts that enable access to the zoom ring of the eyepiece even with the cylinders pushed together. Two operating apertures situated diametrically opposite one another facilitate simultaneous operation using thumb and index finger.

In a further refinement of the invention, at its end assigned to the outer cylinder the inner cylinder has an inwardly overhanging edge surface for seating on the eyepiece housing. The vertical alignment of the clamping device relative to the optical axis is facilitated in this way, and the device is effectively prevented from being wrongly mounted in an oblique or tilted fashion.

The exactly perpendicular alignment of an imaging unit relative to the optical axis of the eyepiece housing is advantageously facilitated by a base plate, on which the clamping device is arranged, flanged on the outer cylinder perpendicular to the optical axis.

In a particular refinement of the device, two rotatably supported threaded spindles that are mutually aligned in a fashion tangential to the outer cylinder and have stationary ends are integrated in the base plate as adjusting means of the clamping device. A particularly compact overall size and a metered exertion of clamping force are enabled in this way.

In an advantageous way, the two threaded spindles can be operated independently of one another by means of spindle heads for the rectilinear individual adjustment of clamping jaws arranged on the base plate. The distance of the clamping jaws can be individually set in this way for clamping the most varied housing shapes. Positioning the taking lens of the imaging device relatively to the optical axis of the eyepiece housing is rendered simple.

The device is distinguished, in particular, in that elastomeric, nonslip clamping pads integrated in the clamping jaws are provided. In this way, on the one hand damage to the imaging housing owing to inadvertent, excessively forceful adjustment of the clamping jaws is prevented, and on the other hand sliding out of the imaging device because of clamping jaws tightened too loosely is counteracted.

The production of the cylinders from a plastics material, for example POM, has proved to be particularly advantageous and cost effective. Disturbing grinding/sliding noises during adjustment of the cylinders relative to one another are counteracted in this way. Persistent disturbing noises can also be effectively avoided by attaching sliding pads made from material resembling felt or velvet either on the outside of the inner cylinder or on the inside of the outer cylinder.

Distortions between the inner cylinder and the outer cylinder are advantageously counteracted by fabricating one of the two cylinders from aluminum. In particular, embodying the inner cylinder in aluminum has proved to be dimensionally stable for the purpose of being able to absorb the forces of the eyepiece/clamping screw connection.

The invention is described and explained in more detail below with the aid of an exemplary embodiment illustrated schematically in the drawing, in which:

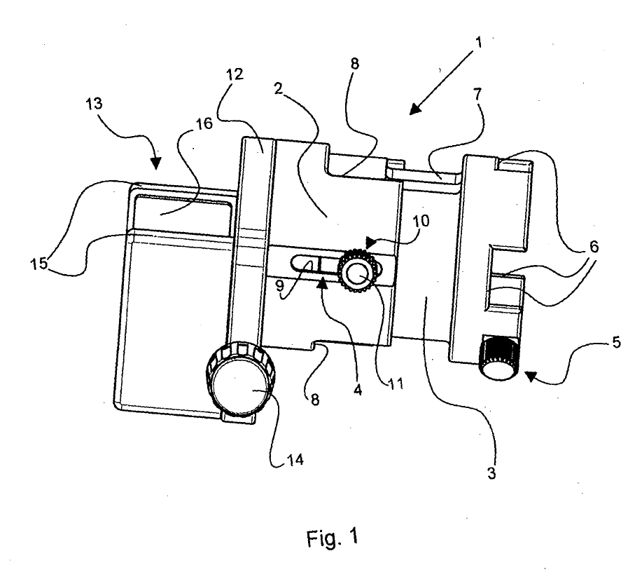

FIG. 1 shows a device for fastening, in a side view,

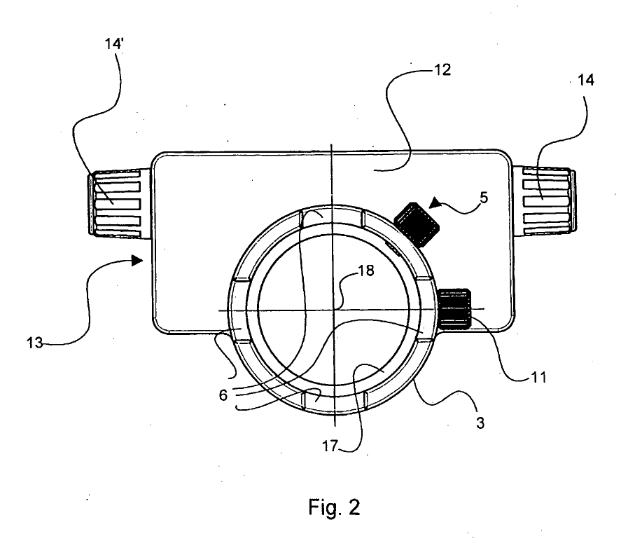

FIG. 2 shows a perpendicular view onto the inner cylinder, from the eyepiece side,

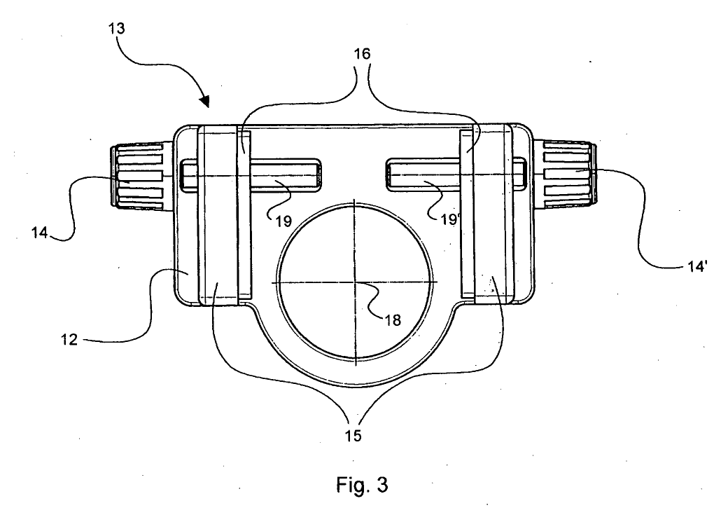

FIG. 3 shows a plan view of the clamping device, and

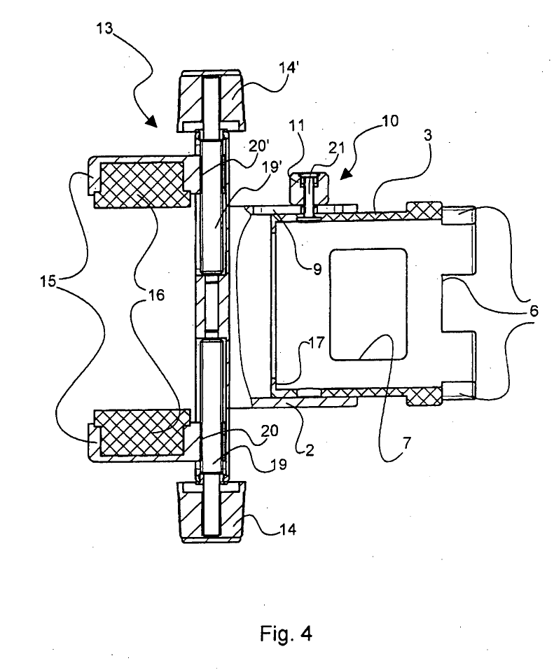

FIG. 4 shows a stepped section both through the clamping device and through the outer and inner cylinders.

FIG. 1 shows in the case of a device 1 for fastening different imaging units (not further illustrated) an outer cylinder 2 that is supported displaceably on an inner cylinder 3 in a rectilinear guide 4. The inner cylinder 3 can be fastened at one of its ends (on the eyepiece side) on an eyepiece housing (not further illustrated) of an observing telescope by means of an eyepiece clamping screw connection 5. Orientation cutouts 6 arranged on the eyepiece side on the inner cylinder 3 in a fashion offset by 90° on the cylinder circumference are provided for the purpose of vertical or horizontal alignment of the device 1 relative to the image edges.

The inner cylinder 3 has operating apertures 7 for the purpose of adjusting a zoom eyepiece. Corresponding cutouts 8 are provided in the outer cylinder 2 in the region of these operating apertures 7.

The rectilinear guide 4 is formed by a pin/slot arrangement in the case of which a threaded pin 21 illustrated in FIG. 4 and fastened in the inner cylinder 3 is guided in a slot 9 running in the outer cylinder 2 in a fashion parallel to the axis thereof. The outer cylinder 2 can be clamped in variable extended positions against the inner cylinder 3 by means of a fixing nut 11 forming a clamping screw connection 10.

A base plate 12 is flanged on the outer cylinder 2 in a fashion perpendicular to the axis thereof. A clamping device 13 is arranged on the base plate 12 in a fashion laterally offset from the cylinder axis. The operation of the clamping device 13 is performed by rotating spindle heads 14 that can move two clamping jaws 15 up to one another independently of one another. Elastomeric nonslip clamping pads 16 are integrated in the clamping jaws 15.

A view from the eyepiece side perpendicularly onto the inner cylinder 3 is illustrated in FIG. 2. Four orientation cutouts 6 are arranged symmetrically on the circumference of the inner cylinder 3. An edge surface 17 overhanging into the interior of the cylinder serves the purpose of seating on an eyepiece housing. A cross shows schematically the position of the cylinder axis 18, and illustrates the base plate 12, which is arranged in a fashion laterally offset therefrom. The spindle heads 14, 14- for operating the clamping device 13 (not further visible here) are located to the left and right on the base plate 12.

Likewise illustrated are the position of the fixing nut 11 and that of the eyepiece clamping screw connection 5.

FIG. 3 shows the individual parts of the clamping device 13 in a plan view. The base plate 12, in which two rotatably supported and mutually aligned threaded spindles 19, 19′ are integrated, is arranged in a fashion laterally offset from the cylinder axis 18. The clamping jaws 15 (cf. the threaded holes 20, 20′ illustrated in FIG. 4) are supported in a mutually displaceable fashion on the threaded spindles 19, 19′. The threaded spindles 19, 19′ are set into rotary motion by rotating the spindle heads 14, 14′. The clamping jaws 15 with their clamping pads 16 can be moved independently of one another in this way.

A stepped section through the clamping device 13, on the one hand, and through the outer and inner cylinders 2, 3, on the other hand, is illustrated in FIG. 4 for the purpose of further explanation of the mode of operation. The clamping pads 16 are embedded in the clamping jaws 15. The threaded spindles 19, 19′ are set in rotary motion when the spindle heads 14, 14′ are rotated, and drive the clamping jaws 15 along positively via threaded holes 20, 20′. The clamping device 13 is flanged on the outer cylinder 2. The inner cylinder 3 is supported displaceably in the outer cylinder 2.

The orientation cutouts 6 and the operating aperture 7 are cut out on the inner cylinder. The edge surface 17 is integrally formed in the inner region. A threaded pin 21 is fastened on the inner cylinder 3 and, together with the slot 9 in the outer cylinder 2, forms a rectilinear guide that can be clamped by the fixing nut 11.

### List of Reference Numerals

1 Device for fastening imaging units on an observing telescope
2 Outer cylinder
3 Inner cylinder
4 Rectilinear guide
5 Eyepiece clamping screw connection
6 Orientation cutouts
7 Operating apertures
8 Cutouts
9 Slot
10 Clamping screw connection
11 Fixing nut
12 Base plate
13 Clamping device
14, 14′ Spindle heads
15 Clamping jaws
16 Clamping pads
17 Edge surface
18 Cylinder axis
19, 19′ Threaded spindles
20, 20′ Threaded holes
21 Threaded pin

1. A device (1) for fastening different imaging units on an observing telescope with exchangeable eyepieces, wherein the device (1) has two cylinders (2, 3) that are supported coaxially with one another and are guided in an axially displaceable fashion, it being possible for one cylinder (3) to be fastened on the eyepiece housing or, via an adapter device surrounding the eyepiece housing, on the housing of the observing telescope, and the other cylinder (2) having a clamping device (13), arranged offset laterally from the cylinder axis, for holding an imaging unit.

2. The device (1) as claimed in patent claim 1, wherein the cylinder bearing the clamping device (13) is guided rectilinearly as outer cylinder (2) on an inner cylinder (3) that can be fastened on the eyepiece housing.

3. The device (1) as claimed in patent claim 2, wherein the outer cylinder (2) can be fixed in variable extended positions on the inner cylinder (3).

4. The device (1) as claimed in patent claim 3, wherein a first clamping screw connection (10) with a fixing nut (11) clamping the outer cylinder (2) against the inner cylinder (3) is provided for the fixing.

5. The device (1) as claimed in patent claim 4, wherein on the eyepiece side the inner cylinder (3) has one or more orientation cutouts (6) arranged on the circumference, and/or a further clamping screw device (5) for fastening on the eyepiece housing.

6. The device (1) as claimed in patent claim 5, wherein one or more operating apertures (7) are provided on the inner cylinder (3) for adjusting a zoom eyepiece.

7. The device (1) as claimed in patent claim 6, wherein at its end assigned to the outer cylinder (2) the inner cylinder (3) has an inwardly overhanging edge surface (17) for seating on the eyepiece housing.

8. The device (1) as claimed in claim 1, wherein a base plate (12) which is flanged on perpendicular to the optical axis and on which the clamping device (13) is arranged is provided on the outer cylinder (2).

9. The device (1) as claimed in patent claim 8, wherein the two rotatably supported threaded spindles (19, 19′) that are mutually aligned in a fashion tangential to the outer cylinder (2) and have stationary ends are integrated in the base plate (12) as adjusting means of the clamping device (13).

10. The device (1) as claimed in patent claim 9, wherein two threaded spindles (19, 19′) can be operated independently of one another by means of spindle heads (14, 14′) for the rectilinear individual adjustment of clamping jaws (15) arranged on the base plate (12).

11. The device (1) as claimed in patent claim 10, wherein elastomeric, nonslip clamping pads (16) integrated in the clamping jaws (15) are provided.
